(19) United States
(12) Patent Application Publication
(10) Pub. No.: US 2010/0272022 A1
(43) Pub. Date: Oct. 28, 2010

(54) SEQUENCE HOPPING METHOD, WIRELESS COMMUNICATION TERMINAL APPARATUS AND WIRELESS COMMUNICATION BASE STATION APPARATUS

(75) Inventors: Takashi Iwai, Ishikawa (JP); Daichi Imamura, Kanagawa (JP); Yoshihiko Ogawa, Kanagawa (JP); Sadaki Futagi, Ishikawa (JP); Atsushi Matsumoto, Ishikawa (JP); Tomofumi Takata, Ishikawa (JP)

Correspondence Address: Dickinson Wright PLLC;James E. Ledbetter, Esq., International Square, 1875 Eye Street, N.W., Suite 1200, Washington, DC, 20006, US

(73) Assignee: PANASONIC CORPORATION, Osaka (JP)

(21) Appl. No.: 12/809,925

(22) PCT Filed: Dec. 26, 2008
(86) PCT No.: PCT/JP2008/004002

§ 371 Date: Jun. 21, 2010

(30) Foreign Application Priority Data
Dec. 27, 2007 (JP) 2007-337242

(51) Int. Cl. H04W 40/00

(52) U.S. Cl. 370/328

(57) ABSTRACT

A wireless communication terminal apparatus wherein the occurrences of inter-sequence interferences between a reference signal preceding a sequence hopping and a reference signal following the sequence hopping can be reduced so as to improve the randomizing effect achieved by the sequence hopping. In this apparatus, a sequence number deciding part (105) has a table in which the sequence lengths of Zadoff-Chu sequences used for reference signals are associated with the sequence numbers of Zadoff-Chu sequences used for reference signals of a slot #1 and with the sequence numbers of Zadoff-Chu sequences used for reference signals of a slot #2. In accordance with a sequence length according to a transmission bandwidth received from a decoding part (104), the sequence number deciding part (105) refers to the table to decide the sequence number of a Zadoff-Chu sequence. In the table of the sequence number deciding part (105), different hopping amounts are provided to a plurality of slot-#2-specific Zadoff-Chu sequences having different sequence lengths.

### TECHNICAL FIELD

The present invention relates to a sequence hopping method, a radio communication terminal apparatus and a radio communication base station apparatus.

### BACKGROUND ART

In a mobile communication system, a reference signal (RS) is used for uplink or downlink channel estimation. In a radio communication system represented by a 3GPP LTE system (3rd Generation Partnership Project Long Term Evolution), a Zadoff-Chu sequence (hereinafter “ZC sequence”) is adopted as a reference signal that is used in uplink. Reasons that a ZC sequence is adopted as a reference signal include a uniform frequency characteristic, and good auto-correlation and cross-correlation characteristics. A ZC sequence is a kind of CAZAC (Constant Amplitude and Zero Auto-correlation Code) sequence and its time-domain representation is expressed by following equation 1,

$$\begin{matrix}( Equation 1 ) & \\ {f}_{r} ( k ) = \{ \begin{matrix}exp \{ \frac{- j 2 π r}{N} ( \frac{k ( k + 1 )}{2} - p k ) \} , \\ when N is odd , k = 0 , 1 , … , N - 1 \\ exp \{ \frac{- j 2 π r}{N} ( \frac{{k}^{2}}{2} + p k ) \} , \\ when N is even , k = 0 , 1 , … , N - 1\end{matrix} & [ 1 ]\end{matrix}$$

where, “N” is the sequence length, “r” is the ZC sequence index in the time-domain, and “N” and “r” are coprime. Also, “p” represents an arbitrary integer (generally p=0). Although cases will be explained with the following explanation using ZC sequences where sequence length N is an odd number, ZC sequences where sequence length N is an even number will be equally applicable.

A cyclic shift ZC sequence obtained by cyclic-shifting the ZC sequence of equation 1 in the time domain, or a ZC-ZCZ (Zadoff-Chu Zero Correlation Zone) sequence, is represented by following equation 2,

$$\begin{matrix}( Equation 2 ) & \\ {f}_{r , m} ( k ) = exp \{ \frac{- j 2 π r}{N} ( \frac{( k \pm m Δ ) ( k \pm m Δ + 1 )}{2} ) + p k \} , \\ when N is odd , k = 0 , 1 , … , N - 1 & [ 2 ]\end{matrix}$$

where “m” represents the cyclic shift index, “A” represents the cyclic shift interval, and the sign “±” is either positive or negative. Further, N−1 quasi-orthogonal sequences with good cross-correlation characteristics can be generated from a ZC sequence of sequence length N of a prime number. In this case, the cross-correlation between generated N−1 quasi-orthogonal sequences is constant at vN. Furthermore, the sequence obtained by Fourier-transforming the time-domain ZC sequence of equation 1 to a frequency-domain sequence is also a ZC sequence, and therefore a frequency-domain ZC sequence is represented by following equation 3,

$$\begin{matrix}( Equation 3 ) & \\ {F}_{u} ( k ) = exp \{ \frac{- j 2 π u}{N} ( \frac{k ( k + 1 )}{2} + qk ) \} , \\ when N is odd , k = 0 , 1 , … , N - 1 & [ 3 ]\end{matrix}$$

where “N” is the sequence length, “u” is the ZC sequence index in the frequency domain, and “N” and “u” are coprime. Also, “q” represents an arbitrary integer (generally q=0). Likewise, in the frequency-domain representation of the time-domain ZC-ZCZ sequence of equation 2, cyclic shift and phase rotation form a Fourier transform pair, and therefore a frequency-domain ZC-ZCZ sequence is represented by following equation 4,

$$\begin{matrix}( Equation 4 ) & \\ {F}_{u , m} ( k ) = exp \{ \frac{- j 2 π u}{N} ( \frac{k ( k + 1 )}{2} + qk ) \pm \frac{j 2 πΔ m}{N} k \} , \\ when N is odd , k = 0 , 1 , … , N - 1 & [ 4 ]\end{matrix}$$

where “N” is the sequence length, “u” is the ZC sequence index in the frequency domain, and “N” and “u” are coprime, and where “m” represents the cyclic shift index, “Δ” represents the cyclic shift interval and “q” represents an arbitrary integer (generally q=0).

Further, a reference signal for channel estimation used to demodulate data (hereinafter “DM-RS,” which stands for demodulation reference signal) is a reference signal used in an uplink in 3GPP LTE. This DM-RS is transmitted in the same bandwidth as the data transmission bandwidth. That is, when the data transmission bandwidth is narrow, a DM-RS is transmitted in a narrow band. For example, if the data transmission bandwidth is one RB (resource block), the DM-RS transmission bandwidth is also one RB, and, if the data transmission bandwidth is two RBs, the DM-RS transmission bandwidth is also two RBs. In 3GPP LTE, one RB is formed with twelve subcarriers, so that a DM-RS is transmitted in a transmission bandwidth of an integral multiple of twelve subcarriers. Further, sequence length N of a ZC sequence is the maximum prime number among the prime numbers less than the number of subcarriers equivalent to the transmission bandwidth. For example, if a DM-RS is transmitted in 3 RBs (36 subcarriers), a ZC sequence of sequence length N=31 is generated, and, if a DM-RS is transmitted in 4 RBs (48 subcarriers), a ZC sequence of sequence length N=47 is generated.

A ZC sequence having sequence length N of a prime number, does not match the number of subcarriers equivalent to the DM-RS transmission bandwidth (integral multiple of 12). Then, to match a ZC sequence having sequence length N of a prime number with the number of subcarriers equivalent to the DM-RS transmission bandwidth, a ZC sequence of a prime number is subject to cyclic extension, to match the number of subcarriers in the transmission band. For example, by duplicating the first half of a ZC sequence and attaching the duplicated part to the second half, the number of subcarriers equivalent to the transmission bandwidth is matched with the sequence length of the ZC sequence. To be more specific, in cases where there is a 3-RB (36-subcarrier) DM-RS, a ZC sequence of sequence length N=36 is generated by giving a cyclic extension of 5 subcarriers to the ZC sequence of sequence length N=31, and, when a DM-RS is transmitted in 4 RBs (48 subcarriers), a ZC sequence of sequence length N=48 is generated by giving a cyclic extension of 1 subcarrier to the ZC sequence of sequence length N=47.

As described above, in 3GPP LTE, sequence length N varies depending on the reference signal transmission bandwidth (i.e. the numbers of RBs of reference signals). Accompanying this, when the transmission bandwidth varies, the sequence index of the ZC sequence used for a reference signal also varies. Then, in 3GPP LTE, studies are underway to group a plurality of ZC sequences of different sequence lengths N into a plurality of sequence groups. A plurality of sequence groups generated by this grouping method are allocated to cells on a one-by-one basis. In 3GPP LTE, the number of sequence groups is 30 (=N−1) equaling to the number of ZC sequences of sequence length N=31 that can be generated from 3 RBs, the minimum transmission bandwidth (i.e. the minimum number of RBs) using a ZC sequence. Further, in the transmission bandwidths, one sequence is assigned to RBs per one sequence group from 3 RBs to 5 RBs, and two sequences are assigned to RBs of 6 RBs or more per one sequence group.

Here, data transmission bandwidths are determined based on scheduling per cell, and therefore ZC sequences of different transmission bandwidths (different sequence lengths) between cells are transmitted in the same frequency band. In this case, cross-correlation increases significantly in a specific combination of sequence indexes. According to computer simulations conducted by the present inventors, cross-correlation characteristics between ZC sequences in combinations of sequence indexes of varying sequence lengths are as shown in FIG. 1. FIG. 1 shows cross-correlation characteristics between ZC sequence of sequence length N=31 and sequence index u=1 and ZC sequences of sequence length N=59 and sequence indexes u=1 to 6. In FIG. 1, the horizontal axis shows delay time (the number of symbols), and the longitudinal axis shows normalized cross-correlation values (the values obtained by dividing cross-correlation values by signal energy). As shown in FIG. 1, in the combination of the ZC sequence of sequence length N=31 and sequence index u=1 and the ZC sequence of sequence length N=59 and sequence index u=2, the maximum cross-correlation value increases significantly, and the cross-correlation value is about five times the cross-correlation value between quasi-orthogonal sequences of the same sequence length, 1/v31 (=1/vN).

Accordingly, as shown in FIG. 2, when a combination of ZC sequences of high-cross correlation is assigned to neighboring cells, interference between sequences of reference signals (RSs) occurs. Assuming that the reference signal of UE #1 (sequence length N=31 and sequence index u=a) and the reference signal of UE #2 (sequence length N=59 and sequence index u=b) are allocated in cell A to the frequency band shown in FIG. 2, and the reference signal of UE #3 (sequence length N=59 and sequence index u=c) and the reference signal of UE #4 (sequence length N=31 and sequence index u=d) are allocated in cell B neighboring cell A to the frequency band shown in FIG. 2. Here, the cross-correlation between u/N=a/31 and u/N=c/59 is high, and the cross-correlation between u/N=b/59 and u/N=d/31 is high. Consequently, in the frequency bands to which ZC sequences of high-cross correlation are allocated, that is, in the frequency bands to which the reference signal of UE #1 and the reference signal of UP #4 are allocated, interference of sequences of the reference signals between cell A and cell B increases, and therefore the accuracy of channel estimation deteriorates.

Then, in 3GPP LTE, studies are conducted for sequence hopping, whereby sequence indexes u of ZC sequences are made different at predetermined intervals, for the purpose of randomizing interference of sequences of reference signals between cells. In 3GPP LTE, data is transmitted in units of 1 subframe. Further, as shown in FIG. 3, 1 subframe is formed with two slots of slot #1 and slot #2 and a reference signal (RS) is arranged in each slot (e.g. DM-RS). Then, as shown in FIG. 3, sequence hopping is performed by making the sequence indexes of ZC sequences different to use reference signals, RSs, for slots #1 and #2 in 1 subframe. By this means, by randomizing the influence of inter-cell interference received in each terminal, it is possible to reduce interference between sequences persistently in one terminal due to interference signals from other cells, and prevent demodulation performance from deteriorating.

Further, as a method of grouping ZC sequences, the grouping methods shown in FIGS. 4 and 5 are proposed (see Non-Patent Document 1). With the grouping method shown in FIG. 4, in each transmission bandwidth (i.e. in each number of RBs), ZC sequences are assigned to sequence groups in order from a smaller sequence index. To be more specific, as shown in FIG. 4, in transmission bandwidths of 3 RBs to 5 RBs to which one sequence is assigned per one sequence group, one of ZC sequences of sequence indexes u=1, 2 and 3 . . . is assigned to sequence groups 1, 2 and 3 . . . . Further, as shown in FIG. 4, in the transmission bandwidths of 6-RBs or more to which two sequences are assigned per sequence group, two ZC sequences having sequence indexes u=(1,2), (3,4) and (5,6) . . . are assigned to sequence groups 1, 2 and 3 . . . .

With the grouping method of ZC sequences shown in FIG. 5, in each transmission bandwidth (i.e. in each number of RBs), ZC sequences are assigned to sequence groups per one sequence in order from the smallest sequence index until the number of ZC sequences is assigned to each sequence group. To be more specific, as shown in FIG. 5, in transmission bandwidths of 3 RBs to 5 RBs to which one sequence is assigned per one sequence group, ZC sequences are assigned in the same way as in the grouping method shown in FIG. 4. Meanwhile, as shown in FIG. 5, in transmission bandwidths of 6-RBs or more to which two sequences are assigned per sequence group, first, ZC sequence of sequence indexes u=1, 2, and 3 . . . are assigned to sequence groups 1, 2 and 3 . . . on a one by one basis. Next, ZC sequences of sequence indexes u-31, 32, and 33 . . . are assigned to sequence groups in order from sequence groups 1, 2 and 3 . . . again on a one by one basis. Accordingly, two ZC sequences having sequence indexes u=(1, 31), (2, 32), and (3,33) . . . are assigned to sequence groups 1, 2 and 3 . . . . In this way, by using the grouping methods shown in FIGS. 4 and 5, sequence groups of ZC sequences to use for reference signals in each transmission bandwidths (i.e. each number of RBs) can be determined, using a small amount of calculation, based on simple sequence assignment rules.

Then, among sequence groups shown in FIGS. 4 and 5, in transmission bandwidths of 6-RBs or more to which two sequences are assigned per sequence group, sequence hopping is performed in every slot cycle, to randomize interference of sequences between cells. To be more specific, ZC sequences of sequence number #1 in each sequence group shown in FIGS. 4 and 5 are used for reference signals (RSs) in slot #1 shown in FIG. 3, and ZC sequences of sequence number #2 are used for reference signals (RSs) in slot #2 shown in FIG. 3. In this way, sequence indexes are switched every slot cycle.

### Non-Patent Document 1: Huawei, R1-073518, “Sequence Grouping Rule for UL DM-RS,” 3GPP TSG RAN WG1 Meeting #50, Athens, Greece, Aug. 20-24, 2007

### DISCLOSURE OF INVENTION

### Problems to be Solved by the Invention

FIGS. 6 and 7 show the distribution of u/Ns of ZC sequences (ZC sequences of sequence indexes u shown in FIGS. 4 and 5) grouped into a plurality of sequence groups by the above-described conventional technique. The horizontal axis shows u/Ns and the longitudinal axis shows transmission bandwidths (i.e. the numbers of RBs). As shown in FIGS. 6 and 7, when the ZC sequences have a wider transmission bandwidth (i.e. the number of wider RBs), u/Ns of ZC sequences used for reference signals are concentrated to be zero. For this reason, as shown in FIGS. 6 and 7, it is likely to use ZC sequences showing nearly zero difference in u/N, between different sequence groups of different transmission bandwidths.

As described above, combinations of sequence indexes of high cross-correlation are present among ZC sequences of varying sequence lengths. According to computer simulations conducted by the present inventors, the relationships between u/Ns and maximum cross-correlation values are as shown in FIG. 8. FIG. 8 shows cross-correlation between a desired wave having a 1-RB transmission bandwidth and interference waves having transmission bandwidths of 1 RB to 25 RBs. The horizontal axis shows the difference in u/N between the desired wave and interference waves, and the longitudinal axis shows the maximum cross-correlation values between the desired wave and interference waves. From FIG. 8, when the difference in u/N between ZC sequences becomes close to zero (e.g. the difference in u/N is within 0.02), it is known that the maximum cross-correlation value between those ZC sequences increases (e.g. the maximum cross-correlation value is equal to or more than 0.7).

Accordingly, when ZC sequences are used for reference signals of wider transmission bandwidths (i.e. greater numbers of RBs), the difference in u/N between ZC sequences of different transmission bandwidths (i.e. of the different numbers of RBs) becomes close to zero and therefore the cross-correlation between the ZC sequences increases. For example, the differences in u/N become close to zero both of between two ZC sequences in sequence group 2 of a 24-RB (or 25-RB) transmission bandwidth and between two ZC sequences in sequence group 3 of a 24-RB (or 25-RB) transmission bandwidth shown in FIGS. 6 and 7. Accordingly, when these ZC sequences are used between neighboring cells, the reference signal of slot #1 and the reference signal of slot #2 in one subframe in FIG. 3 interfere each other. That is, ZC sequences are grouped simply in order from the smallest number of sequence index as the above-described conventional technique, reference signals in one subframe between cells to which different sequence groups are assigned are likely to interfere each other between sequences. That is, interference between sequences occurs consecutively between reference signals before and after sequence hopping, and therefore the effect of randomization by sequence hopping cannot be acquired.

It is therefore an object of the present invention to provide a sequence hopping method, a radio communication terminal apparatus and a radio communication base station apparatus that improve the effect of randomization by sequence hopping by reducing interference between sequences in both reference signals before and after sequence hopping.

### Means for Solving the Problem

The sequence index setting method of the present invention that provides a sequence hopping method of performing sequence hopping using a first Zadoff-Chu sequence and a second Zadoff-Chu sequence obtained by adding an amount of hopping to the first Zadoff-Chu sequence, includes the method in which different amounts of hopping are given to a plurality of second ZC sequences having varying sequence lengths.

### ADVANTAGEOUS EFFECTS OF INVENTION

According to the present invention, it is possible to improve the effect of randomization by sequence hopping by reducing interference between sequences in both reference signals before and after sequence hopping.

### BRIEF DESCRIPTION OF DRAWINGS

FIG. 1 shows cross-correlation characteristics between ZC sequences in combinations of different sequence indexes;

FIG. 2 illustrates interference of sequences between cells;

FIG. 3 illustrates sequence hopping between a plurality of slots in one subframe;

FIG. 4 shows a conventional table for determining sequence indexes;

FIG. 5 shows a conventional table for determining sequence indexes;

FIG. 6 shows conventional distribution of u/Ns of ZC sequences to use for reference signals;

FIG. 7 shows conventional distribution of u/Ns of ZC sequences to use for reference signals;

FIG. 8 shows cross-correlation about the difference in u/N between ZC sequences of varying sequence lengths;

FIG. 9 is a block diagram showing a configuration of a terminal according to Embodiment 1 of the present invention;

FIG. 10 is a block diagram showing a configuration of a base station according to Embodiment 1 of the present invention;

FIG. 11 shows a table for determining sequence indexes according to Embodiment 1 of the present invention;

FIG. 12 shows the distribution of u/Ns of ZC sequences to use for reference signals according to Embodiment 1 of the present invention; and

FIG. 13 shows a table for determining sequence indexes (example 1) according to Embodiment 1 of the present invention;

FIG. 14 shows the distribution of u/Ns of ZC sequences to use for reference signals (example 1) according to Embodiment 1 of the present invention;

FIG. 15 shows a table for determining sequence indexes (example 2) according to Embodiment 1 of the present invention;

FIG. 16 shows the distribution of u/Ns of ZC sequences to use for reference signals (example 2) according to Embodiment 1 of the present invention;

FIG. 17A is a block diagram showing another internal configuration of the reference signal generation section according to Embodiment 1 of the present invention;

FIG. 17B is a block diagram showing another internal configuration of the reference signal generation section according to Embodiment 1 of the present invention;

FIG. 18 shows a table for determining sequence indexes according to Embodiment 2 of the present invention; and

FIG. 19 shows the distribution of u/Ns of ZC sequences to use for reference signals according to Embodiment 2 of the present invention.

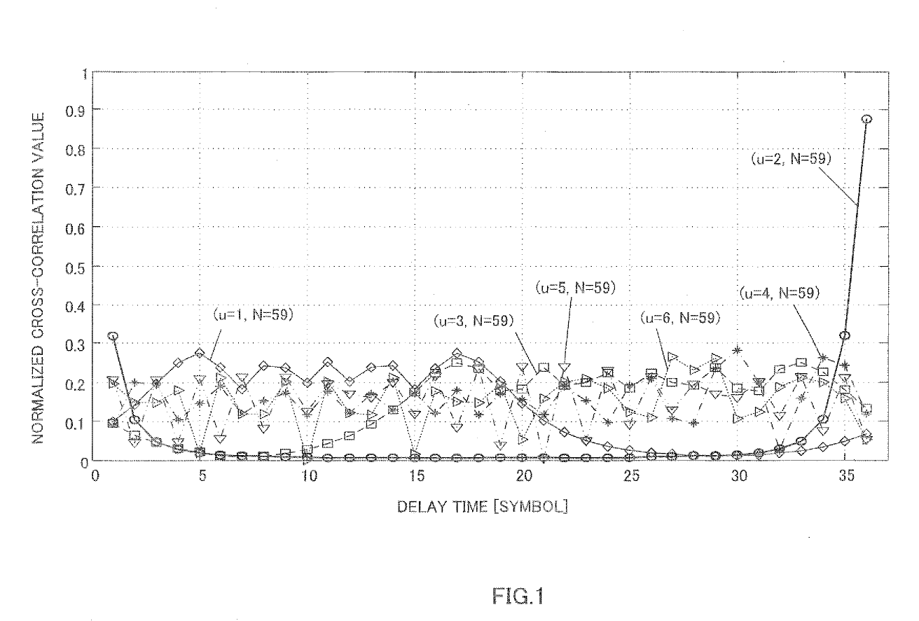

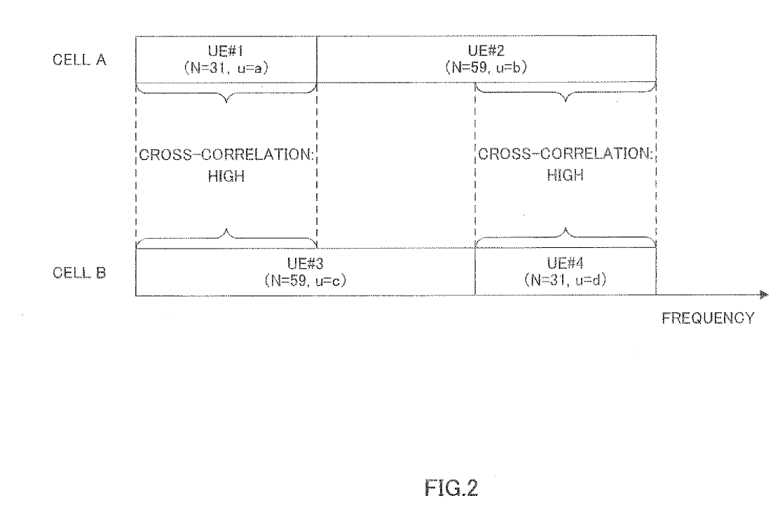

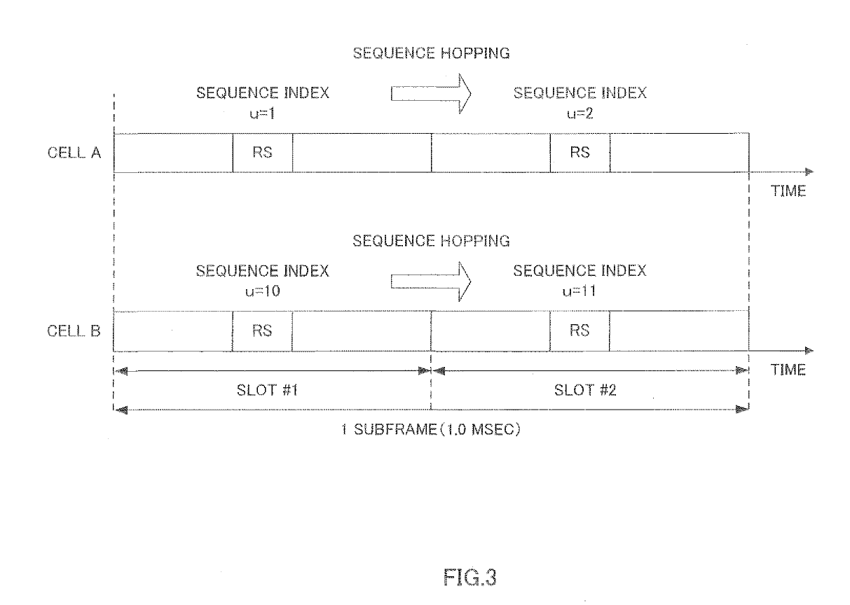

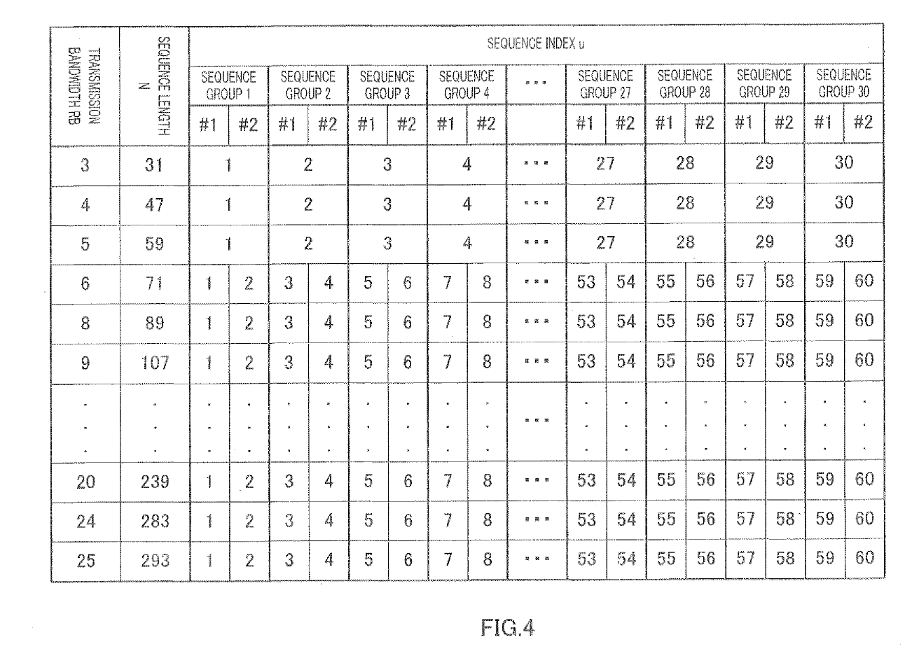

### BEST MODE FOR CARRYING OUT THE INVENTION

Now, embodiments of the present invention will be described in detail with reference to the accompanying drawings. In the following explanation, in transmission bandwidths (i.e. in the numbers of RBs) to which two ZC sequences are assigned per one sequence group, one ZC sequence is used for a reference signal in slot #1 in one subframe and the other ZC sequence is used for a reference signal in slot #2 in one subframe. That is, sequence hopping is performed between slot #1 and slot #2 in one subframe.

### Embodiment 1

With the present embodiment, different amounts of hopping are given to a plurality of ZC sequences of varying sequence lengths.

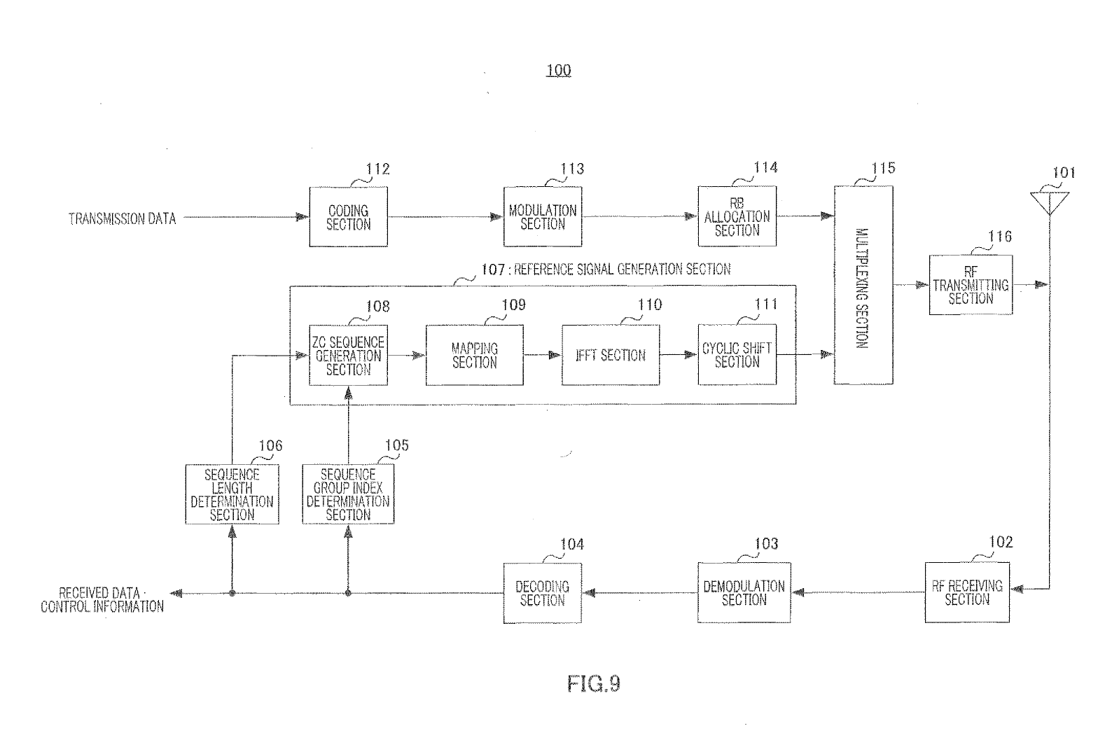

The configuration of terminal 100 according to the present embodiment will be described using FIG. 9.

RF receiving section 102 of terminal 100 shown in FIG. 9 performs receiving processing including down-conversion and A/D conversion on a signal received via antenna 101, and outputs the signal subjected to receiving processing to demodulation section 103.

Demodulation section 103 performs equalization processing and demodulation processing on the signal received as input from RF receiving section 102, and outputs the signal after these processing to decoding section 104.

Decoding section 104 decodes the signal received as input from demodulation section 103, and extracts received data and control information. Then, decoding section 104 outputs the sequence group index among the extracted control information to sequence index determination section 105, and outputs the reference signal transmission bandwidth (i.e. the number of RBs) to sequence index determination section 105 and sequence length determination section 106.

Sequence index determination section 105 has a table in which sequence group indexes of a plurality of sequence groups grouping a plurality of ZC sequences of varying sequence lengths and sequence lengths of ZC sequences to use for reference signals, and sequence indexes of ZC sequences (ZC sequences to use for reference signals in slot #1 and ZC sequences to use for reference signals in slot #2), are associated. Then, sequence length determination section 105 determines a sequence index of a ZC sequence according to the sequence group number received as input from decoding section 104 and the sequence length corresponding to the transmission bandwidth (i.e. the number of RBs) received as input from decoding section 104, with reference to the table. Further, in the table in sequence index determination section 105, different amounts of hopping are given to ZC sequences of varying sequence lengths to use for a plurality of reference signals in slot #2. Then, sequence index determination section 105 outputs the determined sequence index to ZC sequence generation section 108 in reference signal generation section 107.

Based on the transmission bandwidth (i.e. the number of RBs) received as input from decoding section 104, sequence length determination section 106 determines the sequence length of a ZC sequence. To be more specific, sequence length determination section 106 determines the maximum prime number among the prime numbers smaller than the number of subcarriers equivalent to the transmission bandwidth (i.e. to the number of RBs), to be the sequence length of a ZC sequence. Then, sequence length determination section 106 outputs the determined sequence length to ZC sequence generation section 108 in reference signal generation section 107.

Reference signal generation section 107 has ZC sequence generation section 108, mapping section 109, IFFT (Inverse Fast Fourier Transform) section 110 and cyclic shift section 111. Then, reference signal generation section 107 generates as a reference signal a ZC sequence obtained by adding a cyclic shift to the ZC sequence generated in ZC sequence generation section 108. Then, reference signal generation section 107 outputs the generated reference signal to multiplexing section 115. Now, the internal configuration of reference signal generation section 107 will be described.

ZC sequence generation section 108 generates a ZC sequence based on the sequence index received as input from sequence index determination section 105 and the sequence length received as input from sequence length determination section 106. Then, ZC sequence generation section 108 outputs the generated ZC sequence to mapping section 109.

Mapping section 109 maps the ZC sequence received as input from ZC sequence generation section 108 to the band corresponding to the transmission bandwidth of terminal 100. Then, mapping section 109 outputs the mapped ZC sequence to IFFT section 110.

IFFT section 110 performs IFFT processing for the ZC sequence received as input from mapping section 109. Then, IFFT section 110 outputs the ZC sequence after IFFT processing to cyclic shift section 111.

Based on the predetermined amount of cyclic shift, cyclic shift section 111 cyclic-shifts for the ZC sequence received as input from IFFT section 110. Then, cyclic shift section 111 outputs the cyclic-shifted ZC sequence to multiplexing section 115.

Coding section 112 encodes transmission data, and outputs the encoded data to modulation section 113.

Modulation section 113 modulates the encoded data received as input from coding section 112, and outputs the modulated signal to RB allocation section 114.

RB allocation section 114 allocates the modulated signal received as input from modulation section 113 to the band (RB) corresponding to the transmission bandwidth of terminal 100, and outputs the modulated signal allocated to the band (RB) corresponding to the transmission bandwidth of terminal 100, to multiplexing section 115.

Multiplexing section 115 time-multiplexes the transmission data (modulated signal) received as input from RB allocation section 114 and the ZC sequence (reference signal) received as input from cyclic shift section 111 of reference signal generation section 107, and outputs the multiplexed signal to RF transmitting section 116. The multiplexing method in multiplexing section 115 is not limited to time multiplexing, and may be frequency multiplexing, code multiplexing and IQ multiplexing on a complex space.

RF transmitting section 116 performs transmission processing, including D/A conversion, up-conversion and amplification, on the multiplexed signal received as input from multiplexing section 115, and transmits via radio the signal after the transmission processing from antenna 101 to the base station.

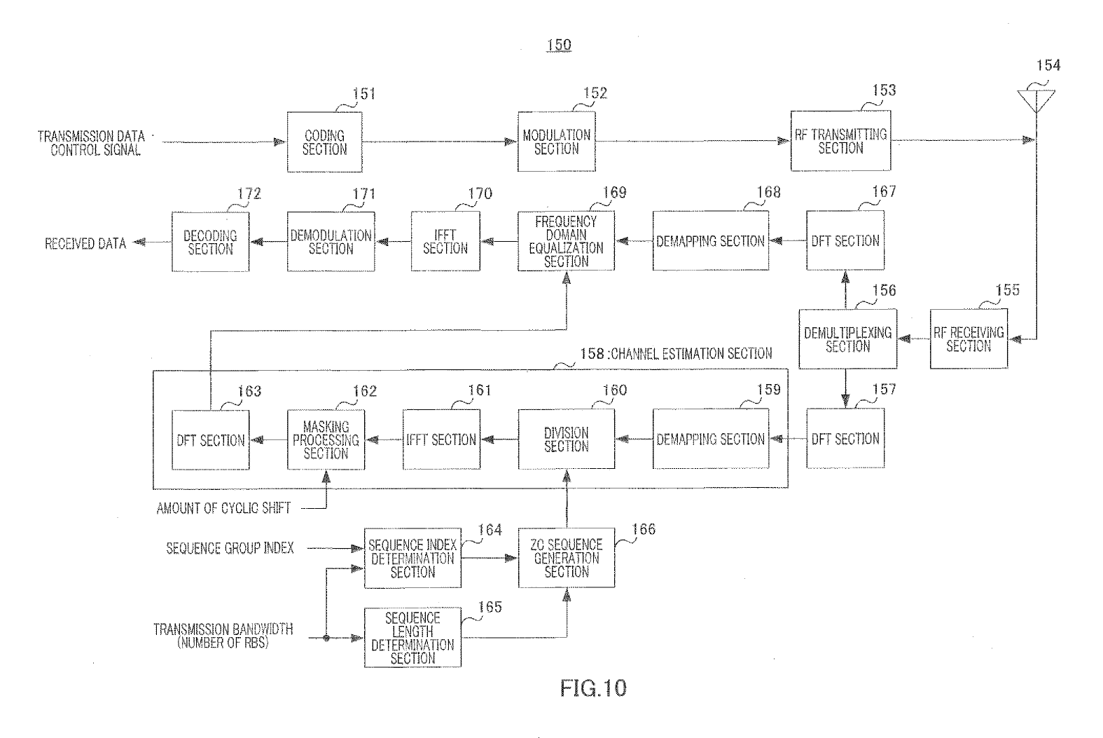

Next, the configuration of base station 150 according to the present embodiment will be explained using FIG. 10.

Coding section 151 in base station 150 shown in FIG. 10 encodes transmission data and a control signal, and outputs the encoded data to modulation section 152. The control signal includes a sequence group index showing the sequence group allocated to base station 150 and the transmission bandwidth (i.e. the number of RBs) of the reference signal transmitted by terminal 100.

Modulation section 152 modulates the coded data received as input from coding section 151, and outputs the modulated signal to RF transmitting section 153.

RF transmitting section 153 performs transmission processing, including D/A conversion, up-conversion and amplification, on the modulated signal, and transmits the signal after the transmission processing via radio from antenna 154.

RF receiving section 155 performs receiving processing, including down-conversion and A/D conversion, on a signal received via antenna 154, and outputs the signal after the receiving processing to demultiplexing section 156.

Demultiplexing section 156 demultiplexes the signal outputted from RF receiving section 155 into the reference signal, data signal and control signal. Demultiplexing section 156 outputs the demultiplexed reference signal to DFT (Discrete Fourier transform) section 157 and outputs the data signal and control signal to DFT section 167.

DFT section 157 performs DFT processing on the reference signal received as input from demultiplexing section 156, to transform the time-domain signal to a frequency-domain signal. DFT section 157 outputs the reference signal transformed into the frequency domain, to demapping section 159 of channel estimation section 158.

Channel estimation section 158, which has demapping section 159, division section 160, IFFT section 161, masking processing section 162 and DFT section 163, estimates channels based on the reference signal outputted from DFT section 157. Now, the internal configuration of channel estimation section 158 will be described specifically.

Demapping section 159 extracts the parts corresponding to the transmission band of each terminal from the signal received as input from DFT section 157. Demapping section 159 outputs the extracted signals to division section 160.

Division section 160 divides the signals received as input from demapping section 159 by ZC sequences received as input from ZC sequence generation section 166 (described later). Then, division section 160 outputs the division results (correlation values) to IFFT section 161.

IFFT section 161 performs IFFT processing on the signals outputted from division section 160. Then, IFFT section 161 outputs the signals after the IFFT processing to masking processing section 162.

Based on the amount of cyclic shift received as input, by masking the signals received as input from IFFT section 161, masking processing section 162 as an extraction means extracts the correlation value in the period (the detection window) where the correlation value of the desired cyclic shift sequence is present. Then, masking processing section 162 outputs the extracted correlation value to DFT section 163.

DFT section 163 performs DFT processing on the correlation value received as input from masking processing section 162. Then, DFT section 163 transforms the correlation value after DFT processing to frequency domain equalization section 169. The signal outputted from DFT section 163 shows frequency fluctuation of the channel (the frequency response of the channel).

Sequence index determination section 164 having the same table as in sequence index determination section 105 (FIG. 9) of terminal 100, that is, a table in which sequence group indexes and sequence lengths of ZC sequences to use for reference signals, and the sequence indexes are associated, determines the sequence index according to the sequence group index and the sequence length associated with the transmission bandwidth (i.e. the number of RBs) received as input, with reference to the table. That is, different amounts of hopping are given to ZC sequences of varying sequence lengths to use for a plurality of reference signals in slot #2 in the table in sequence index determination section 164. Then, sequence index determination section 164 outputs the determined sequence index to ZC sequence generation section 166.

Based on the transmission bandwidth (i.e. based on the number of RBs) received as input, sequence length determination section 165 determines the sequence length of a ZC sequence similar to sequence length determination section 106 of terminal 100 (FIG. 9). Then, sequence length determination section 165 outputs the determined sequence length to ZC sequence generation section 166.

Similar to ZC sequence generation section 108 of terminal 100 (FIG. 9), ZC sequence generation section 166 generates a ZC sequence based on the sequence index received as input from sequence index determination section 164 and the sequence length received as input from sequence length determination section 165. Then, ZC sequence generation section 166 outputs the generated ZC sequence to division section 160 in channel estimation section 158.

Meanwhile, DFT section 167 performs DFT processing on the data signal and the control signal received as input from demultiplexing section 156, to transform the time-domain signal to a frequency-domain signal. DFT section 167 outputs the data signal and control signal transformed into the frequency domain, to demapping section 168.

Demapping section 168 extracts the parts of the data signal and control signal corresponding to the transmission band of each terminal from the signal received as input from DFT section 167, and outputs the extracted signals to frequency domain equalization section 169.

Frequency domain equalization section 169 performs equalization processing on the data signal and control signal received as input from demapping section 168, using the signal received as input from DFT section 163 in channel estimating section 158 (the frequency response of the channel). Frequency domain equalization section 169 outputs the signals subjected to equalization processing to IFFT section 170.

IFFT section 170 performs IFFT processing on the data signal and control signal received as input from frequency domain equalization section 169. IFFT section 170 outputs the signals subjected to IFFT processing to demodulation section 171.

Demodulation section 171 demodulates the signals received as input from IFFT section 170, and outputs the signals subjected to demodulation processing to decoding section 172.

Decoding section 172 decodes the signals received as input from demodulation section 171, and extracts received data.

Next, an example of sequence hopping in sequence index determination section 105 of terminal 100 (FIG. 9) and sequence index determination section 164 of base station 150 (FIG. 10) will be explained.

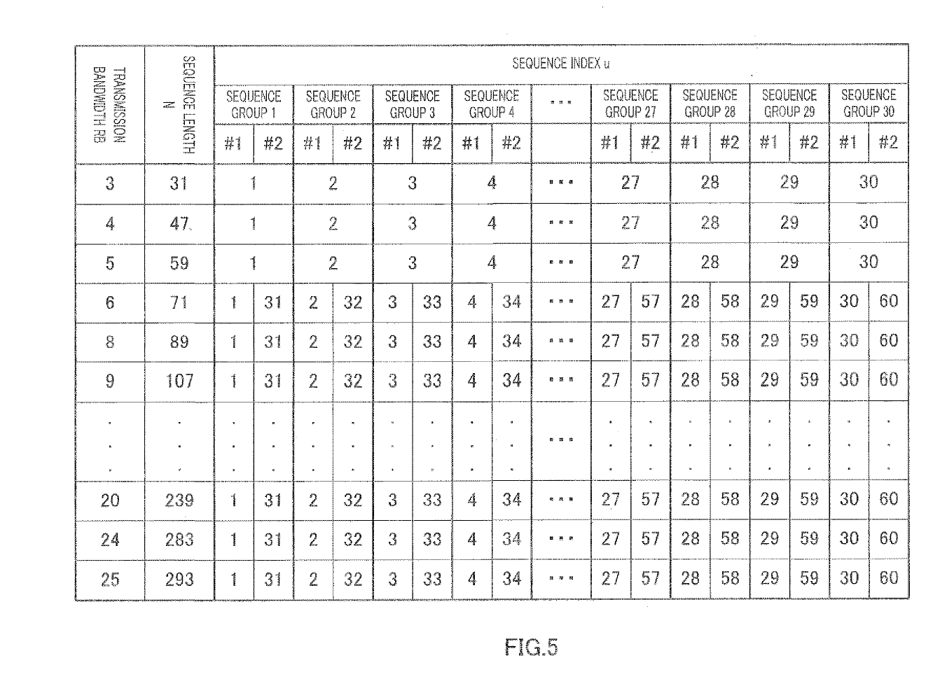

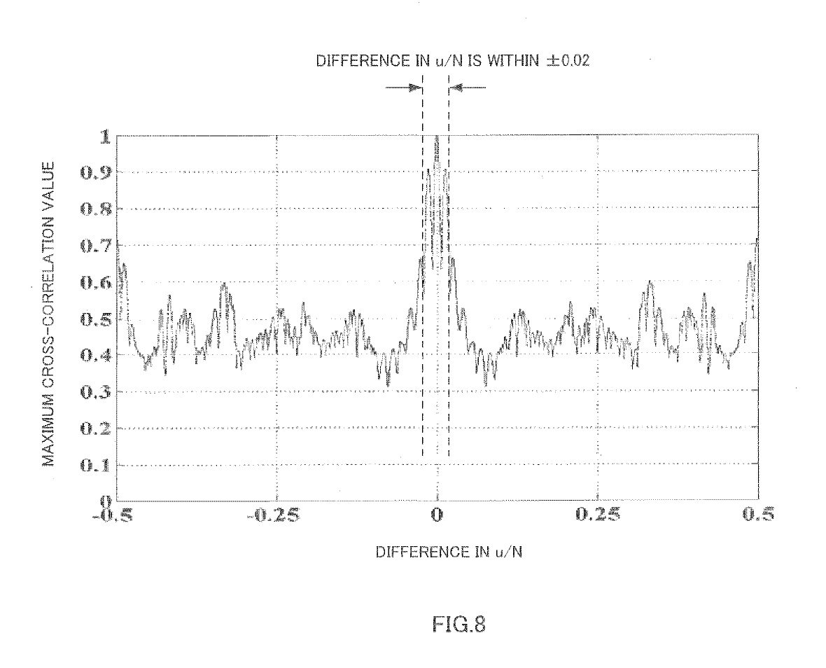

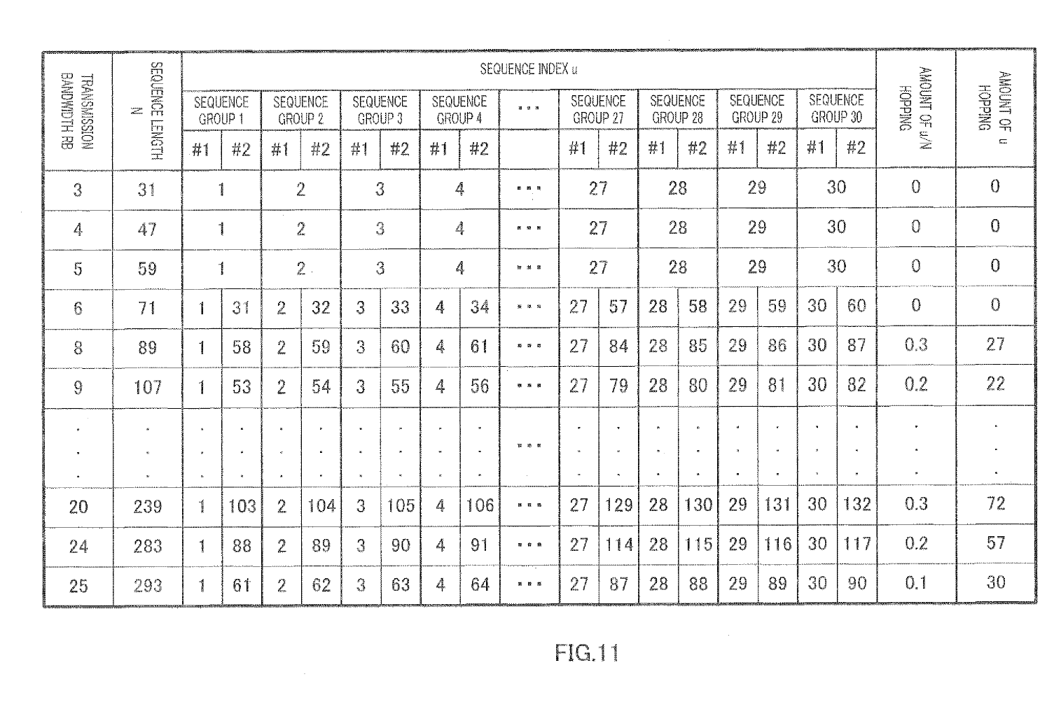

In the following explanation, the number of sequence groups is thirty (sequence groups 1 to 30). Further, as the reference signal transmission bandwidth (i.e. the number of RBs), the number of RBs is equal to or more than three and is a multiple of two, three or five. Specifically, as the reference signal transmission bandwidth (i.e. the number of RBs), 3 RBs, 4 RBs, 5 RBs, 6 RBs, 8 RBs, 9 RBs, 10 RBs, 12 RBs, 15 RBs, 16 RBs, 18 RBs, 20 RBs, 24 RBs and 25 RBs are used. Further, 1 RB is formed with 12 subcarriers. Further, sequence length N of a ZC sequence is the maximum prime number equal to or less than the number of subcarriers equivalent to each transmission bandwidth (i.e. to each number of RBs). To be more specific, as shown in FIG. 11, assuming that the sequence length N is 31 in 3 RBs (36 subcarriers), the sequence length N is 47 in 4 RBs (48 subcarriers), and the sequence length N is 59 in 5 RBs (60 subcarriers). The same will apply to a case where the transmission bandwidth (i.e. the number of RBs) is 6 RBs to 25 RBs. Here, one ZC sequence is assigned per one sequence group in transmission bandwidths of 3 RBs to 5 RBs and two ZC sequences (slot #1 ZC sequence and slot #2 ZC sequence) are assigned per one sequence group in transmission bandwidths of 6 RBs or more. That is, in transmission bandwidths (i.e. the numbers of RBs) of 3 RBs to 5 RBs, 30 ZC sequences (=1×30 groups) are used as reference signals in each transmission bandwidth (i.e. in each number of RBs), and with transmission bandwidth of 6 RBs or more, 60 ZC sequences (=2×30 groups) are used as reference signals in each transmission bandwidth (i.e. in each number of RBs). Further, similar to the grouping method shown in FIG. 5, the sequence indexes of ZC sequences of each transmission bandwidth (i.e. of each number of RBs) are assigned on a per sequence basis to sequence groups 1 to 30, until the number of sequences to be assigned to each sequence groups is fulfilled. Further, here, when the difference in u/N between ZC sequences is equal to or more than 0.1 (the cross-correlation characteristics shown in FIG. 8 are equal to or less than 0.5), it is assumed that the cross-correlation between the ZC sequences is low. Further, the table shown in FIG. 11 is held in sequence index determination section 105 and sequence index determination section 164.

With the present embodiment, different amounts of hopping are given to slot #2 ZC sequences of varying sequence lengths. Specifically, the different amounts of hopping given to ZC sequences to use for slot #2 reference signals are the values obtained by multiplying varying sequence lengths N of the ZC sequences to use for slot #2 reference signals by the amounts of u/N bopping. That is, the amount of hopping of ZC sequences to use for a slot #2 reference signal is calculated by following equation 5.

u_{hopping}=ceil(the sequence length N of a ZC sequence to use in a transmission bandwidth)×(the amount of u/N hopping)) (Equation 5)

Here, ceil(x) means rounding up after the decimal point of x.

For example, as shown in FIG. 11, in the 6-RB transmission bandwidth, sequence length N of the ZC sequence is 71 and the amount of u/N hopping is zero, and therefore u_{hopping}=ceil (71×0)=0 by equation 5. Further in the 8-RB transmission bandwidth, sequence length N of the ZC sequence is 89 and the amount of u/N hopping is 0.3, and therefore u_{hopping}=ceil (89×0.3)=27. Likewise, as shown in FIG. 11, in the 24-RB transmission bandwidth, sequence length N of the ZC sequence is 283 and the amount of u/N hopping is 0.2, and therefore u_{hopping}=ceil (283×0.2)=57. Further in the 25-RB transmission bandwidth, sequence length N of the ZC sequence is 293 and the amount of u/N hopping is 0.1, and therefore u_{hopping}=ceil (293×0.1)=30. The same will apply to transmission bandwidths of 5 RBs to 20 RBs.

The amount of change in the amount of u/N hopping for slot #2 ZC sequences in the neighboring transmission bandwidths (i.e. neighboring numbers of RBs) is 0.1 as shown in FIG. 11. That is, the start positions of slot #2 ZC sequences in neighboring transmission bandwidths (i.e. in neighboring numbers of RBs) are determined at positions where the difference in u/N between ZC sequences is 0.1 and where the cross-correlation between ZC sequences decreases.

Then, in each transmission bandwidth (i.e. in each number of RBs), sequence index #1 of ZC sequences to use for reference signals in slot #1 is assigned according to equation 6, and sequence index #2 of ZC sequences to use for reference signals in slot #2 is assigned according to equation 7,

Sequence index #1=G (Equation 6)

Sequence index #2=sequence index #1+M+u_{hopping} (Equation 7)

where “G” represents the sequence group index (here, G=1 to 30) and “M” represents the number of sequence groups (here, M=30).

Accordingly, as shown in FIG. 11, sequence indexes u=1 to 30 from equation 6 are assigned to sequence index #1 of sequence groups 1 to 30 (G=1 to 30).

Further, for example, as shown in FIG. 11, in the 6-RB transmission bandwidth (u_{hopping}=0), from equation 7, sequence index u=31 (=1+30+0) is assigned to sequence index #2 in sequence group 1, sequence index u=32 (=2+30+0) is assigned to sequence index #2 in sequence group 2, and sequence index u=33 (=3+30+0) is assigned to sequence index #2 in sequence group 3. The same will apply to sequence groups 4 to 30 in the 6-RB transmission bandwidth.

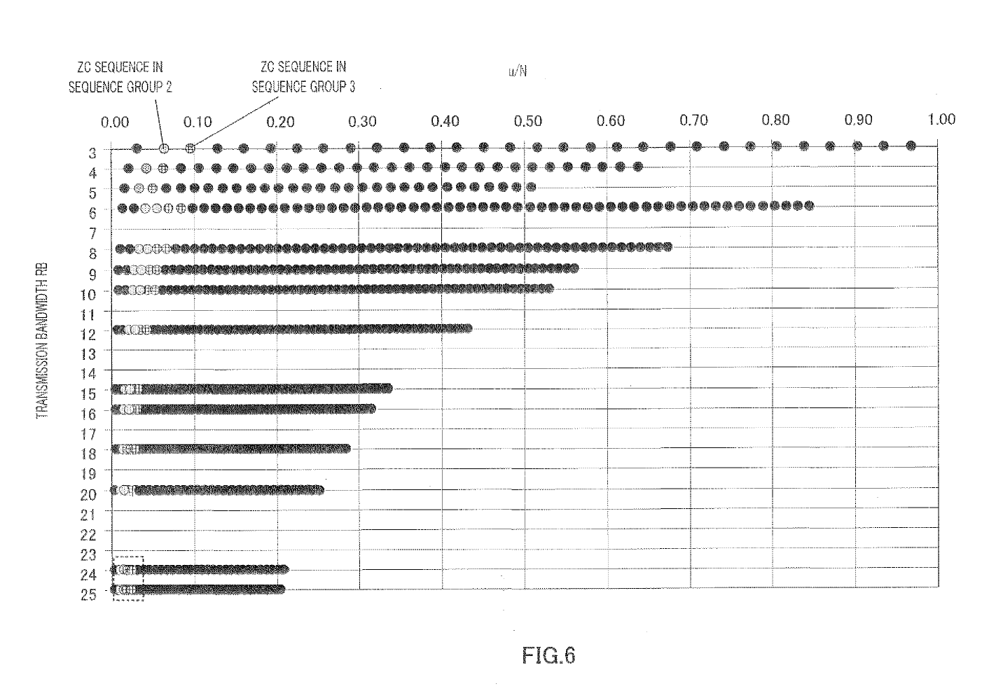

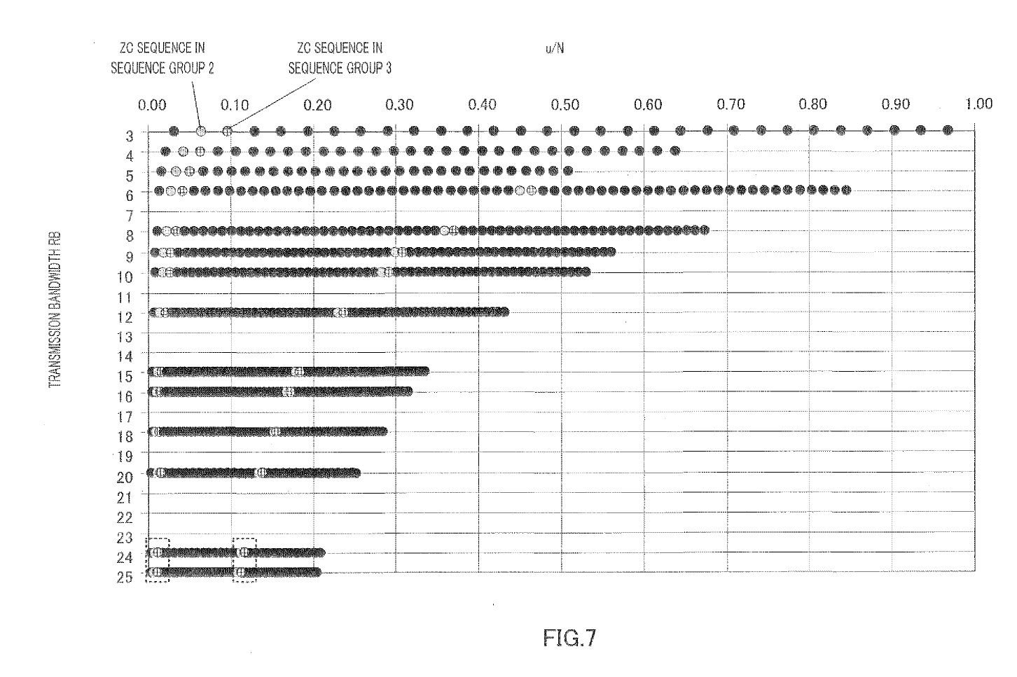

Further, as shown in FIG. 6, in the 25-RB transmission bandwidth (u_{hopping}=30), from equation 7, sequence index u=61 (=1±30+30) is assigned to sequence index #2 in sequence group 1, sequence index u=62 (=2+30+30) is assigned to sequence index #2 in sequence group 2, and sequence index u=63 (=3+30+30) is assigned to sequence index #2 in sequence group 3. The same will apply to sequence groups 4 to 30 in the 25-RB transmission bandwidth.

Regarding transmission bandwidths of 4 RBs to 24 RBs, sequence indexes are assigned in the same way. In this way, with ZC sequences to use for slot #2 reference signals, different amounts of hopping are given to ZC sequences of different transmission bandwidths (i.e. of different numbers of RBs), that is, to ZC sequences of varying sequence lengths.

Then, sequence index determination section 105 of terminal 100 (FIG. 9) and sequence index determination section 164 of base station 150 (FIG. 10) have a table in which sequence indexes of ZC sequences to use for reference signals are assigned as described above and which is shown in FIG. 11, determines a sequence index based on the sequence group index and the sequence length in associated with transmission bandwidths (i.e. the numbers of RBs). Assuming that sequence group 2 is assigned to base station 150 and the transmission bandwidth of the reference signal transmitted by terminal 100 belonging to base station 150 is 20 RBs (sequence length N=239). In this case, sequence index determination section 105 of terminal 100 (FIG. 9) and sequence index determination section 164 of base station 150 (FIG. 10) output sequence index #1=2 and sequence index #2=104 associated with a 20-RB transmission bandwidth (sequence length N=239) and sequence group 2 with reference to the table shown in FIG. 11. Then, terminal 100 performs sequence hopping by using the ZC sequence of sequence index u=2 as a reference signal for slot #1 and the ZC sequence of sequence index u=104 as a reference signal for slot #2.

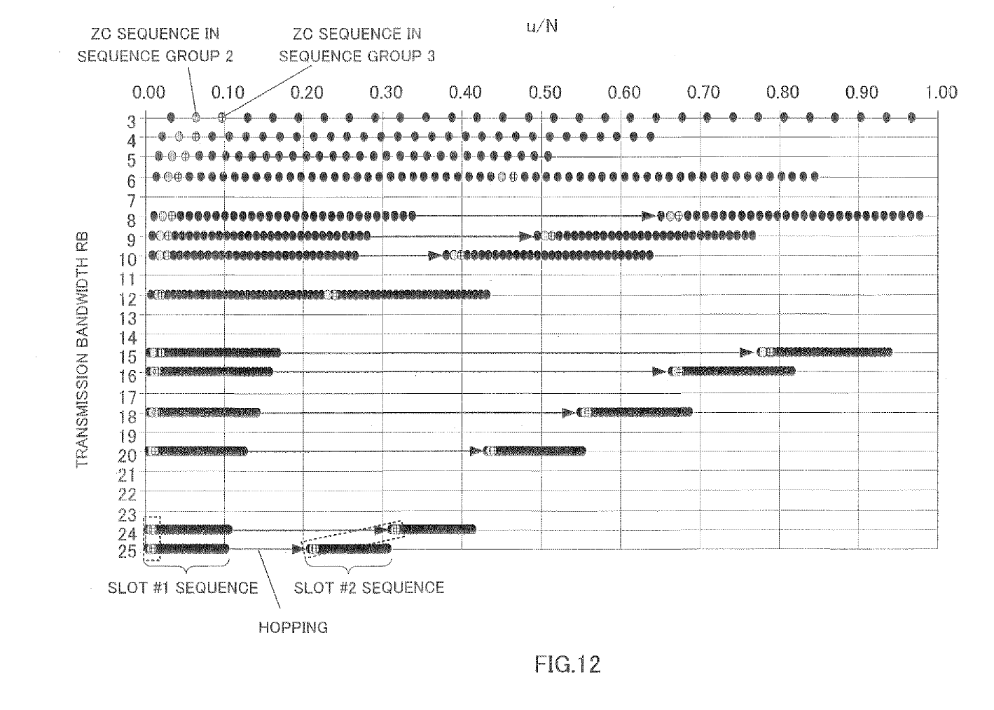

Next, FIG. 12 shows the distribution of u/Ns of the ZC sequences used for reference signals (i.e. ZC sequences assigned in the table shown in FIG. 11). For example, in the 6-RB transmission bandwidth, the amount of sequence index hopping u_{hopping}=0, and therefore slot #1 ZC sequences and slot #2 ZC sequences shown in FIG. 12 are continuous in the 6-KB transmission bandwidth (the amount of u/N hopping becomes zero). Further, in the 8-RB transmission bandwidth, the amount of sequence index hopping u_{hopping}=27, and therefore the u/N of the tail slot #1 ZC sequence and the u/N of the head slot #2 ZC sequence in the 8-RB transmission bandwidth shown in FIG. 12 are distributed in a hopping manner over the amount of u/N hopping, 0.3 (˜27/89). Likewise, in the 25-RB transmission bandwidth, the amount of sequence index hopping u_{hopping}=30, and therefore the u/N of the tail slot #1 ZC sequence and the u/N of the head slot #2 ZC sequence in the 25-RB transmission bandwidth shown in FIG. 12 are distributed in a bopping manner over the amount of u/N hopping, 0.1 (~30/293).

In this way, as shown in FIG. 12, in each transmission bandwidth (i.e. in each number of RBs), the start position of u/N of the ZC sequence to use for a reference signal in slot #2 in one subframe, that is, the start position of u/N of the ZC sequence to use for a reference signal after sequence hopping varies between transmission bandwidths (i.e. between the numbers of RBs). Particularly, between neighboring transmission bandwidths (i.e. the neighboring numbers of RBs), the start positions of u/Ns of ZC sequences to use for slot #2 reference signals are distributed 0.1 apart. In this way, u/Ns of slot #2 ZC sequences of each transmission bandwidth (i.e. of each number of RBs) are distributed in a dispersed manner, so that it is possible to reduce the difference in u/N between ZC sequences of different transmission bandwidths (i.e. of different numbers of RBs) in different sequence groups nearly zero. By this means, the interference between slot #2 ZC sequences of different transmission bandwidths (i.e. different numbers of RBs) is reduced, so that it is possible to acquire the effect of randomizing interference between sequences by sequence hopping.

For example, in FIG. 12, the focus is placed upon two ZC sequences (sequence indexes u=2 and 89) in sequence group 2 in the 24-RB transmission bandwidth (sequence length N=283) and two ZC sequences (sequence indexes u=3 and 63) in sequence group 3 in the 25-RB transmission bandwidth (sequence length N=293). Here, in the ZC sequences to use in slot #1, the difference between the u/N (=2/283) of the ZC sequence (sequence index u=2) in sequence group 2 in the 24-RB transmission bandwidth and the u/N (=3/293) of the ZC sequence (sequence index u=3) in sequence group 3 in the 25-RB transmission bandwidth is a value near zero. Accordingly, cross-correlation between the ZC sequences to use in slot #1 becomes high, and therefore interference occurs between the sequences. Meanwhile, in the ZC sequences to use in slot #2, the difference between the u/N (=89/283) of the ZC sequence (sequence index u=89) in sequence group 2 in the 24-RB transmission bandwidth and the u/N (=63/293) of the ZC sequence (sequence index u=63) in sequence group 3 in the 25-RB transmission bandwidth becomes about 0.1. Accordingly, with ZC sequences to use in slot #2, cross-correlation between the ZC sequences becomes low, and therefore interference does not occur between sequences. That is, even when interference occurs between sequences in one reference signal (a slot #1 reference signal) in one subframe, it is possible to prevent interference between sequences from occurring in the other reference signal (a slot #2 reference signal). Accordingly, it is possible to acquire randomizing effect of interference between sequences by sequence hopping.

In this way, according to the present embodiment, different amounts of hopping are given to slot #2 ZC sequences having varying sequence lengths (ZC sequences to use for reference signals after hopping). By this means, u/Ns of ZC sequences to use for slot #2 reference signals (reference signals after hopping) are dispersed over each transmission bandwidth (i.e. over each number of RBs). By this means, ZC sequences to use for slot #2 reference signals in different transmission bandwidths (i.e. different numbers of RBs) are less likely to interfere each other. That is, even when interference occurs between ZC sequences to use for reference signals in one slot in one subframe, it is possible to prevent interference from occurring between ZC sequences to use for reference signals in the other slot. Accordingly, the proportion of interference between sequences is reduced between reference signals in both slots in one subframe. In this way, according to the present embodiment, it is possible to reduce the interference between sequences in reference signals both before and after sequence hopping, thereby improving the effect of randomization by sequence hopping.

Further, with the present embodiment, when a ZC sequence to use for a reference signal is determined, by only adding a predetermined and fixed amount of hopping to a sequence index of a ZC sequence to use for a reference signal before hopping, sequence indexes of ZC sequences to use for reference signals after hopping are determined, so that it is possible to improve the effect of randomizing the interference between sequences without increasing the amount of processing and without increasing the amount of used memory.

Although a case has been explained with the present embodiment where, regarding the amount of hopping of a ZC sequence to use for slot #2 reference signal of each transmission bandwidth (i.e. of each number of RBs), the amount of change in the amount of u/N hopping between neighboring transmission bandwidths (i.e. between neighboring numbers of RBs) is 0.1 based on the cross-correlation characteristics shown in FIG. 8, according to the present invention, the amount of change in the amount of u/N hopping between neighboring transmission bandwidths (i.e. between neighboring numbers of RBs) is not necessary 0.1. For example, when a cross-correlation value is accepted about up to 0.7 in the cross-correlation characteristics shown in FIG. 8, the amount of hopping of ZC sequences may be set such that the amount of change in the amount of u/N hopping between neighboring transmission bandwidths (i.e. between neighboring numbers of RBs) is 0.05.

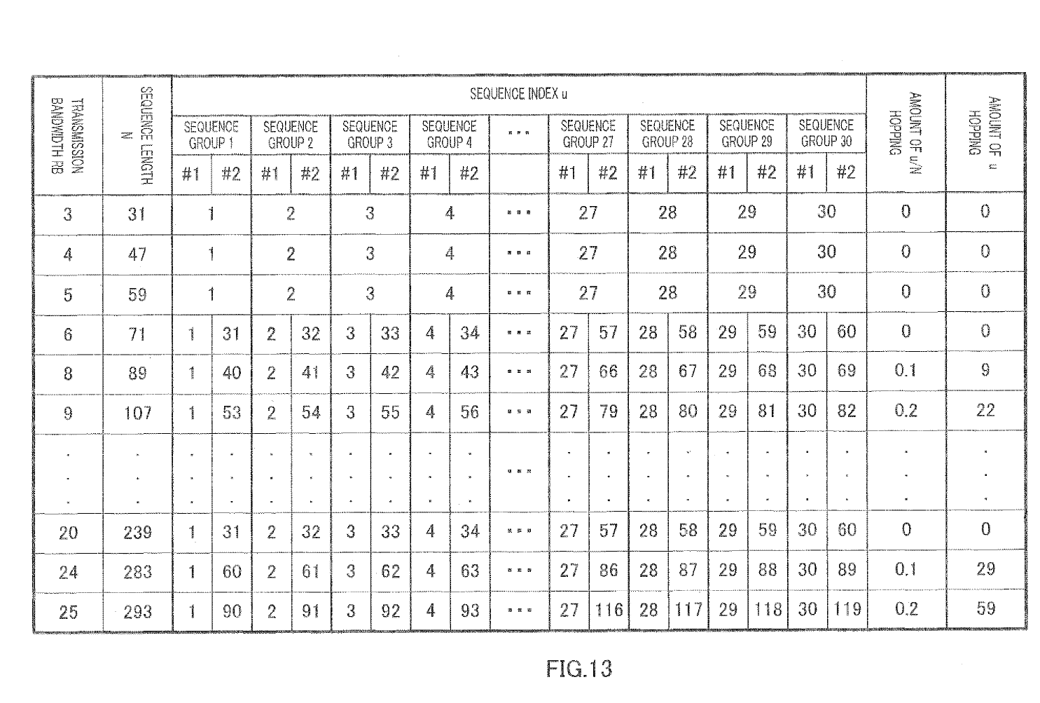

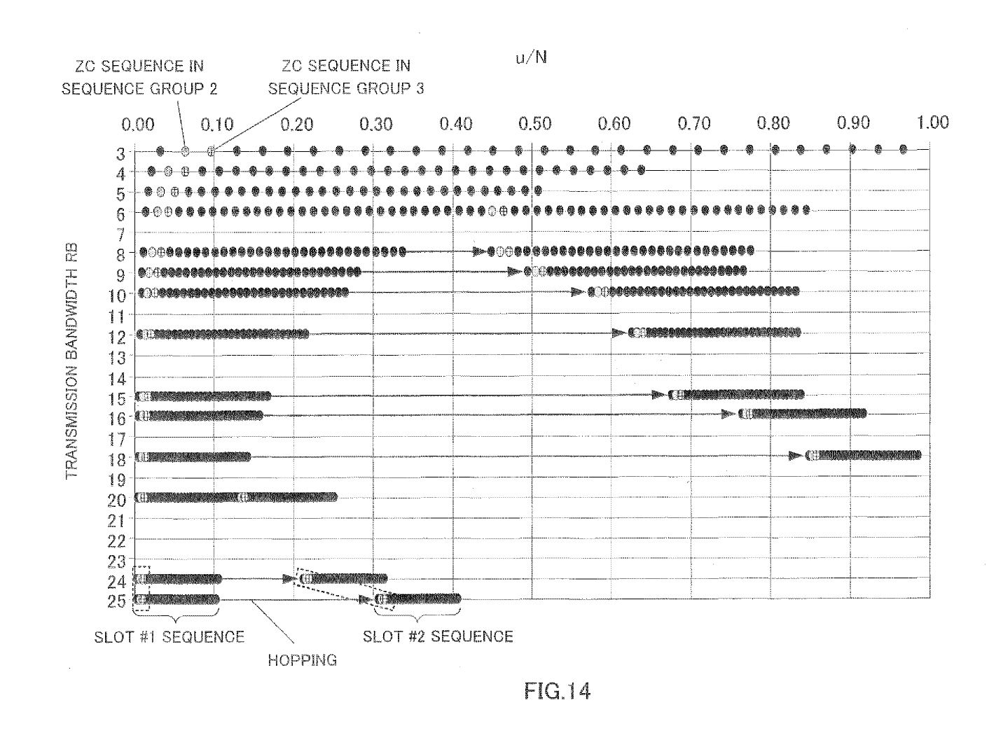

Further, although a case have been explained with the present embodiment where, every time the transmission bandwidth (i.e. the number of RBs) increases, the amount of u/N hopping decreases by a fixed amount of change (the amount of change 0.1 in FIG. 11) until the amount of u/N hopping becomes zero, the present invention is not limited to the amount of u/N hopping shown in FIG. 11. For example, every time a transmission bandwidth (i.e. the number of RBs) increases, the amount of u/N hopping may increase by a fixed amount of change (the amount of change 0.1 in FIG. 13) until the amount of u/N hopping becomes zero. By this means, FIG. 14 shows the distribution of u/Ns of ZC sequences to use for reference signals. As shown in FIG. 14, starting positions of u/Ns of ZC sequences to use for slot #2 reference signals are different on a per transmission bandwidth basis (i.e. the number of RBs) as in the present embodiment, so that it is possible to provide the same advantage as in the present embodiment.

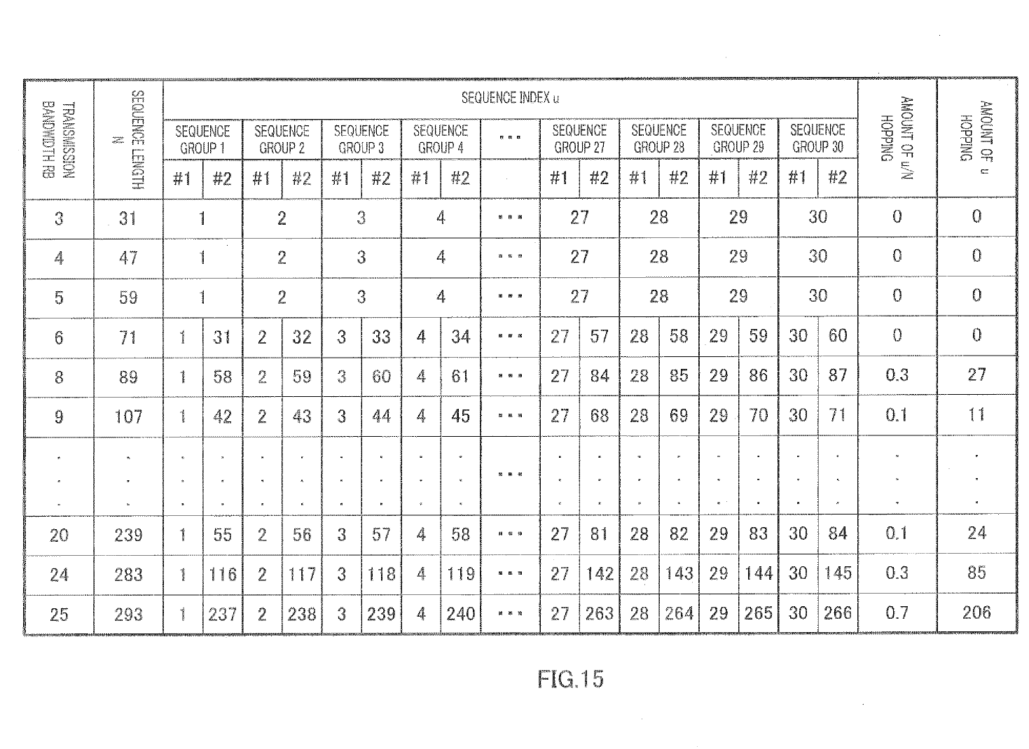

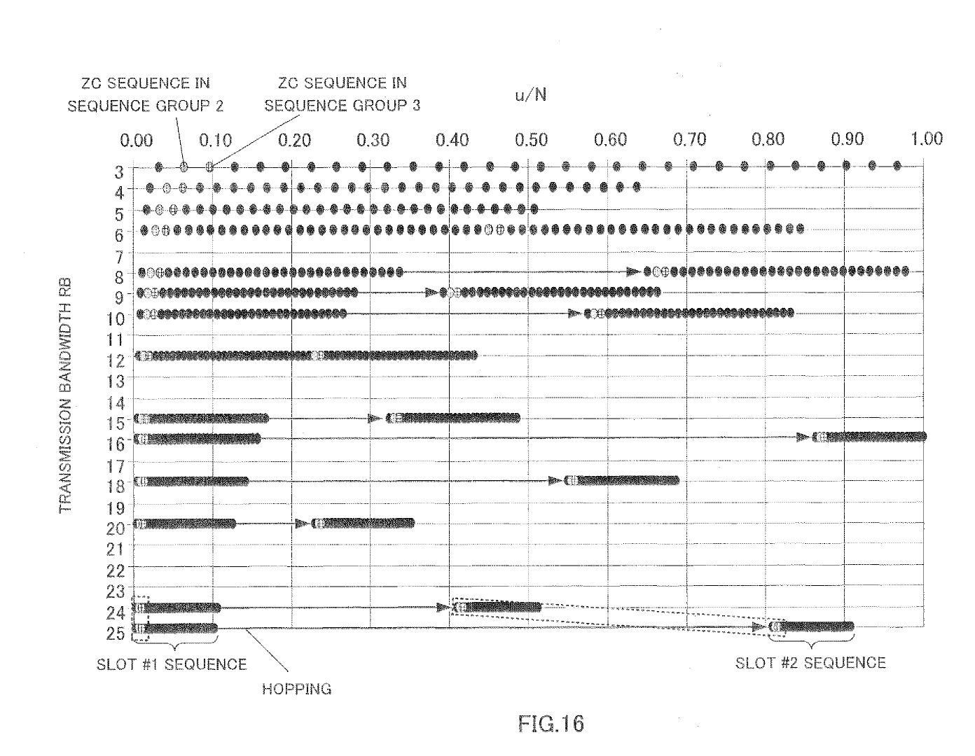

Further, with the present embodiment, the amount of u/N hopping of ZC sequences to use for slot #2 reference signals may be set in each transmission bandwidth on a random basis. For example, as shown in FIG. 15, the amounts of u/N hopping in the transmission bandwidths of 6 RBs, 8 RBs, 9 RBs, . . . , 20 RBs, 24 RBs and 25 RBs are 0.0, 0.3, 0.1, . . . , 0.1, 0.3 and 0.7, respectively. At this time the amounts of hopping for sequence indexes in the transmission bandwidths of 6 RBs, 8 RBs, 9 RBs, . . . , 20 RBs, 24 RBs and 25 RBs are 0, 27, 11, . . . , 24, 85 and 206, respectively. As shown in FIG. 15, assuming that the difference in the amount of hopping between u/N in neighboring transmission bandwidths (i.e. in the neighboring numbers of RBs) is equal to or more than 0.1 as in the present embodiment. Accordingly, as shown in FIG. 16, the amount of u/N hopping for ZC sequences to use for reference signals in each transmission bandwidth (i.e. in each number of RBs) changes on a random basis, so that u/Ns of ZC sequences to use for reference signals in each transmission bandwidth (i.e. in each number of RBs) are distributed in a more dispersed manner than in the present embodiment. By this means, while the amount of used memory to hold the amount of hopping increases by setting up the amount of hopping in each transmission bandwidth on a random basis, u/Ns of ZC sequences to use for slot #2 reference signals (reference signals after hopping) are able to be dispersed further. That is; by setting the amount of hopping in each transmission bandwidth on a random basis, it is possible to improve the effect of randomization further by sequence hopping.

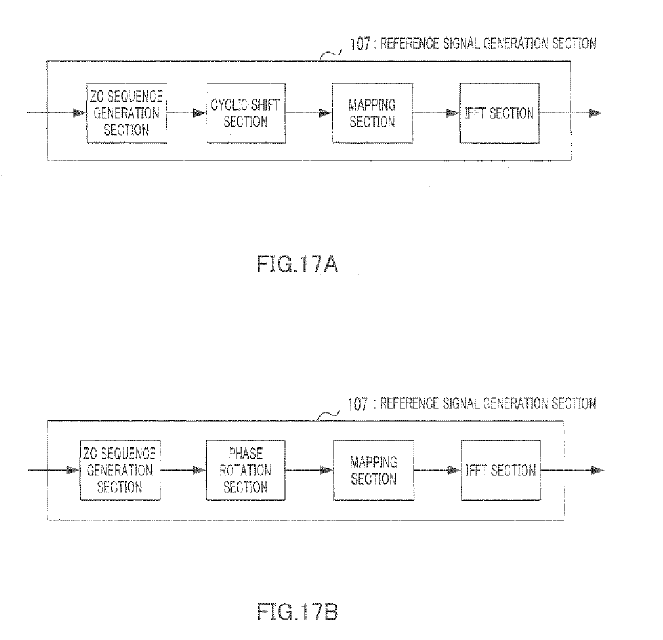

Further, although a case has been explained with the present embodiment where reference signal generation section 107 in terminal 100 is shown in FIG. 9, the section may be configured as shown in FIGS. 17A and 17B. Reference signal generation section 107 shown in FIG. 17A has a cyclic shift section before the IFFT section. Reference signal generation section 107 shown in FIG. 17B has a phase rotation section instead of the cyclic shift section before the IFFT section. This phase rotation section performs phase rotation as equivalent frequency-domain processing instead of cyclic-shifting in the time domain. That is, the amounts of phase rotation corresponding to the amounts of cyclic shift are assigned to subcarriers. These configurations make it possible to reduce the interference between sequences.

Further, although a case has been explained with the present embodiment where a frequency-domain ZC sequence (equation 3) is generated, it is equally possible to generate a time-domain ZC sequence (equation 1).

### Embodiment 2

With the present embodiment, in addition, different offsets between ZC sequences of varying sequence lengths are given to ZC sequences to use for reference signals in slot #1 (i.e. reference signals before hopping) in one subframe.

Now, an example of setting offsets and the amount of hopping of sequence indexes in sequence index determination section 105 of terminal 100 (FIG. 9) and sequence index determination section 164 of base station 150 (FIG. 10) will be explained.

Here, the same transmission bandwidths (i.e. the same numbers of RBs), sequence lengths N and sequence groups are used as transmission bandwidths (i.e. the numbers of RBs), sequence lengths N and sequence groups shown in FIG. 11 of Embodiment 1. Further, here, when the difference in u/N between ZC sequences is equal to or more than 0.05 (the cross-correlation characteristics shown in FIG. 8 are equal to or less than 0.7), it is assumed that the cross-correlation between the ZC sequences is low.

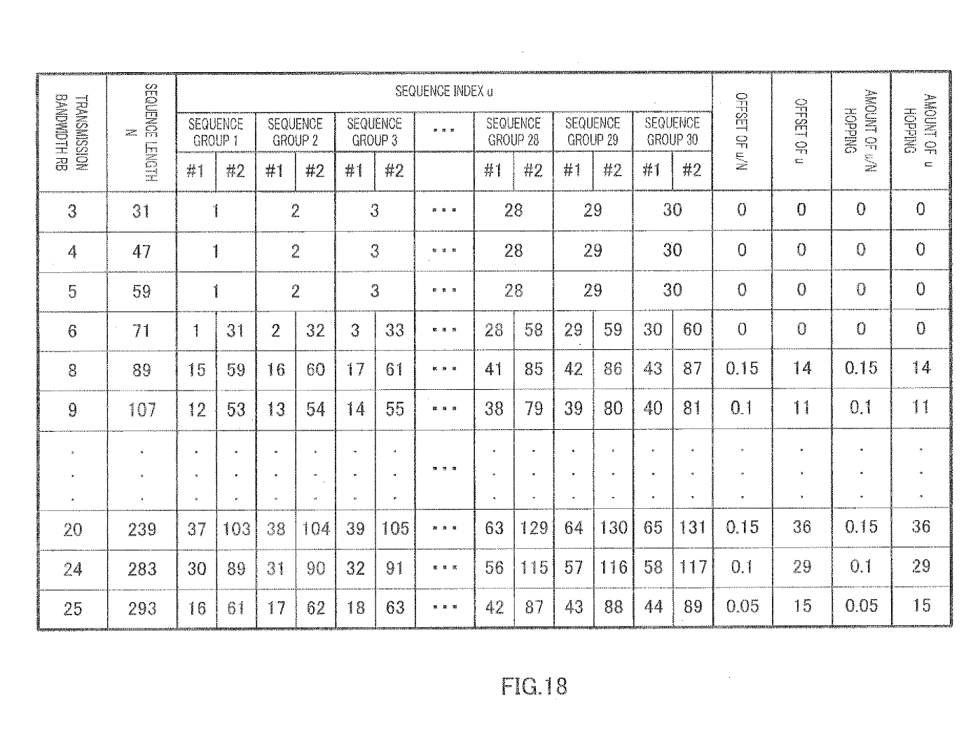

For example, similar to the amounts of hopping given to ZC sequences to use for slot #2 reference signals of Embodiment 1, u_{offset} given to ZC sequences to use for slot #1 reference signals of each transmission band is the values obtained by multiplying sequence length N of ZC sequences of varying sequence lengths by offsets of u/N. For example, as shown in FIG. 18, if the offset of u/N in a 6-RB transmission bandwidth is zero, the offset of sequence indexes u is zero. Further, if the offset of u/N in a 8-RB transmission bandwidth is 0.15, the offset of sequence indexes u is 14. Likewise, if the offset of u/N in a 9-RB transmission bandwidth is 0.1, the offset of sequence indexes u is 11. The same will apply to transmission bandwidths of 10 RBs to 25 RBs.

Then, in each transmission bandwidth, sequence index #1 of ZC sequences to use for slot #1 reference signals is assigned according to equation 8, and sequence index #2 of ZC sequences to use for slot #2 reference signals is assigned according to equation 9,

Sequence index #1=G+u_{offset} (Equation 8)

Sequence index #2=sequence index #1+M+u_{hopping} (Equation 9)

where “G” represents the sequence group index (here, G=1 to 30) and “M” represents the number of sequence groups (here, M=30).

Accordingly, as shown in FIG. 18, in the 6-RB transmission bandwidth (u_{offset}=0), from equation 8, sequence index u=1 (=1+0) is assigned to sequence index #1 in sequence group 1, sequence index u=2 (=2+0) is assigned to sequence index #1 in sequence group 2, and sequence index u=3 (=3+0) is assigned to sequence index #1 in sequence group 3. The same will apply to sequence groups 4 to 30 in the 6-RB transmission bandwidth.

Further, as shown in FIG. 18, in the 25-RB transmission bandwidth (u_{offset}=15), from equation 8, sequence index u=16 (=1+15) is assigned to sequence index #1 in sequence group 1, sequence index u=17 (=2+15) is assigned to sequence index #1 in sequence group 2, and sequence index u=18 (=3+15) is assigned to sequence index #1 in sequence group 3. The same will apply to sequence groups 4 to 30 in the 25-RB transmission bandwidth.

Regarding transmission bandwidths of 4 RBs to 24 RBs, sequence indexes are assigned in the same way. Further, as shown in FIG. 18, sequence indexes are assigned to sequence index #2 of sequence groups of each transmission bandwidth (i.e. of each number of RBs) by equation 9 as in Embodiment 1. By this means, with ZC sequences to use for slot #1 reference signals, different offsets are given to ZC sequences of varying sequence lengths, with ZC sequences to use for slot #2 reference signals, different amounts of hopping are given to ZC sequences of varying sequence lengths.

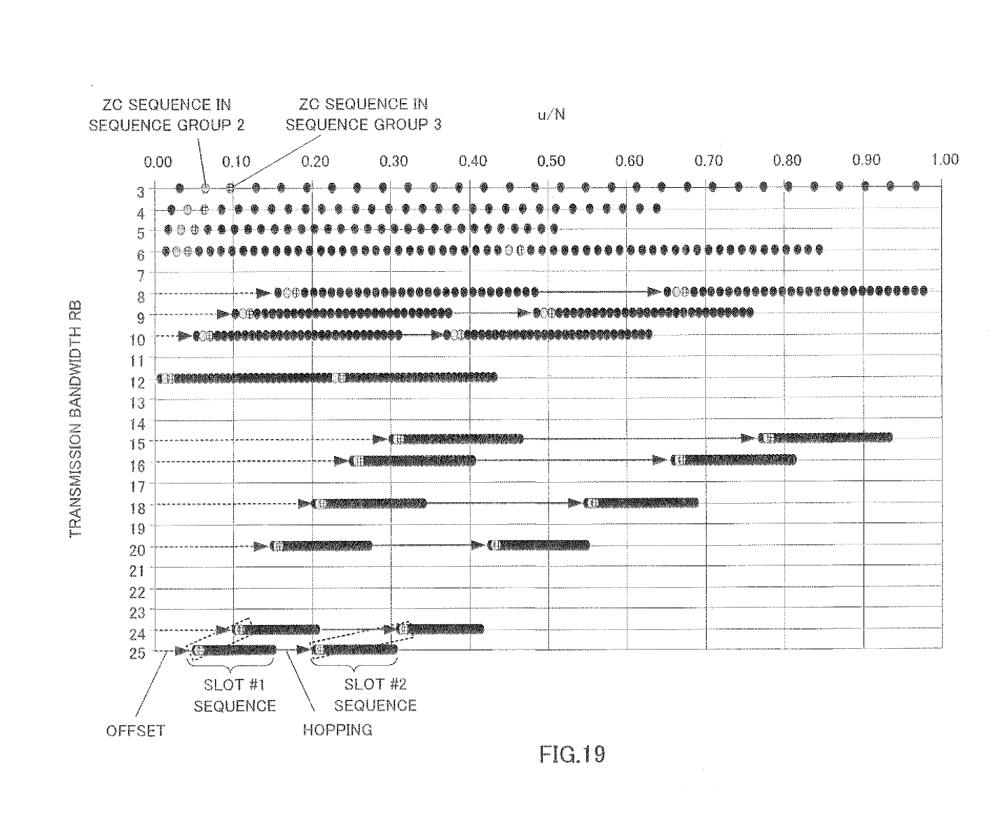

Next, FIG. 19 shows the distribution of u/Ns of the ZC sequences to use for reference signals (i.e. ZC sequences assigned in the table shown in FIG. 18). As shown in FIG. 19, different offsets (see dotted arrows shown in FIG. 19) in each transmission bandwidth (i.e. in each number of RBs) are given to u/Ns of the ZC sequences to use for slot #1 reference signals, and different amounts of hopping (see solid arrows shown in FIG. 19) in each transmission bandwidth (i.e. in each number of RBs) are given to u/Ns of the ZC sequences to use for slot #2 reference signals. By this means, the start positions of u/Ns of ZC sequences to use for slot #1 reference signals and the start positions of u/Ns of ZC sequences to use for slot #2 reference signals vary on a per transmission bandwidth basis. That is, u/Ns of slot #2 ZC sequences in each transmission bandwidth are not only dispersed as in Embodiment 1, but u/Ns of slot #1 ZC sequences in each transmission bandwidth are also distributed in a dispersed manner. Accordingly, it is possible to further reduce the difference in u/N between ZC sequences of different transmission bandwidths (i.e. of different numbers of RBs) in different sequence groups nearly zero. By this means, it is possible to reduce interference between slot #1 ZC sequences and between slot #2 ZC sequences of different transmission bandwidths (i.e. of different numbers of RBs). That is, it is possible to acquire the effect of randomizing interference between sequences by sequence hopping in a plurality of reference signals in one subframe.

For example, in FIG. 19, the focus is placed upon two ZC sequences (sequence indexes u=31 and 90) in sequence group 2 in the 24-RB transmission bandwidth (sequence length N=283) and upon two ZC sequences (sequence indexes u=18 and 63) in sequence group 3 in the 25-RB transmission bandwidth (sequence length N=293). Here, in the ZC sequences to use in slot #1, the difference between the u/N (=31/283) of the ZC sequence (sequence index u=31) in sequence group 2 in the 24-RB transmission bandwidth and the u/N (=18/293) of the ZC sequence (sequence index u=18) in sequence group 3 in the 25-RB transmission bandwidth is about 0.05. Accordingly, cross-correlation between the ZC sequences to use in slot #1 becomes low, and therefore interference between the sequences does not occur. Meanwhile, in the ZC sequences to use in slot #2, the difference between the u/N (=90/283) of the ZC sequence (sequence index u=90) in sequence group 2 in the 24-RB transmission bandwidth and the u/N (=63/293) of the ZC sequence (sequence index u=63) in sequence group 3 in the 25-RB transmission bandwidth is about 0.1. Accordingly, even when ZC sequences are used in slot #2, the cross-correlation between the ZC sequences becomes low as in slot #1, and therefore interference between sequences does not occur. That is, it is possible to prevent interference between sequences of two reference signals in one subframe. That is, it is possible to further improve the effect of randomizing interference between sequences by sequence hopping.

In this way, according to the present embodiment, an offset is given to a ZC sequence to use for a reference signal in slot #1 in one subframe. By this means, it is possible to not only reduce the interference between ZC sequences to use for slot #2 reference signals, which are reference signals after frequency hopping, but also reduce the interference between ZC sequences to use for slot #1 reference signals. That is, according to the present embodiment, it is possible to improve the effect of randomizing interference between sequences by sequence compared with Embodiment 1.

Embodiments of the present invention have been explained.

With the above embodiments, it is not necessary to provide an upper limit to the amount of hopping for sequence indexes. When the amount of hopping for sequence indexes exceeds the number of sequences that can be used in a transmission bandwidth, a sequence index may be calculated by cycling the sequence index to sequence index u=1 of the minimum sequence index. That is, a result of modulo calculation of a calculated sequence index by the number of sequences that can be used in the transmission bandwidth may be used as a sequence index.

Although cases have been explained with the above embodiments where ceil(x) is used in equation 5, with the present invention, ceil(x) needs not be used in equation 5. For example, floor(x) or round(x) may be used in equation 5. Here, floor(x) means rounding down after the decimal point of x and round(x) means rounding off after the decimal point of x.

Further, u_{hopping} calculated in equation 5 in the above embodiments may be calculated with decimals without rounding to an integer (e.g. ceil(x) as described above). In this case, rounding integer processing, that is, either floor(x), ceil(x) or round(x) may be performed for the sequence index acquired by using u_{hopping}.

Although cases have been explained with the above embodiments where terminal 100 and base station 150 have the same table in advance, and sequence lengths and sequence groups are associated with sequence indexes, according to the present invention, terminal 100 and base station 150 do not need to have the same table in advance, and it is not necessary to use a table by making association equivalent to the association among sequence lengths and sequence groups, and sequence indexes.

Further, although eases have been explained with the above embodiments as an example where the terminals transmit data and reference signals to the base station, it is equally possible to apply cases where the base station performs transmission for terminals.

Although cases have been explained with the above embodiments where a ZC sequence is used as a channel estimation reference signal, with the present invention, a ZC sequence may be used as a DM-RS (Demodulation RS), which is a demodulation reference signal for a PUSCH (Physical Uplink Shared Channel), and may be used as a DM-RS, which is a demodulation reference signal for a PUCCH (Physical Uplink Control Channel), and a sounding RS for received quality measurement. Further, a reference signal may be replaced with a pilot signal.

Further, the method of processing in base station 100 is not limited to the above and may be any method as long as the desired wave and interference waves can be separate. For example, cyclic-shifted ZC sequences instead of ZC sequences generated in ZC sequence generation section 166 may be outputted to division section 160. Specifically, division section 160 divides signals received as input from demapping section 159 by cyclic-shifted ZC sequences (the same sequences as the cyclic-shifted ZC sequences transmitted in the transmission side), and outputs the division results (correlation values) to IFFT section 161. Then, by masking the signals received as input from IFFT section 161, masking processing section 162 extracts the correlation value in the period where the correlation value of the desired cyclic shift sequence is present, and outputs the extracted correlation value to DFT section 163. Here, masking processing section 162 does not need to take into account the amount of cyclic shift upon extracting the period where the correlation value of the desired cyclic shift sequence is present. These processing make it possible to separate the desired wave and interference waves from a received wave.

Although cases have been explained with the above embodiments as an example of a ZC sequence having an odd-numbered sequence length, the present invention may be applicable to a ZC sequence having an even-numbered sequence length. Further, the present invention may be applicable to a GCL (Generalized Chirp Like) sequence including a ZC sequence. Now, a GCL sequence will be represented using equations. A GCL sequence of sequence length N is represented by equation 10 when NT is an odd number, or represented by equation 11 when N is an even number.

$$\begin{matrix}( Equation 10 ) & \\ {c}_{r , m} ( k ) = exp \{ \frac{- j 2 π r}{N} ( \frac{k ( k + 1 )}{2} + qk ) \} {b}_{i} ( k mod m ) & [ 5 ] \\ ( Equation 11 ) & \\ {c}_{r , m} ( k ) = exp \{ \frac{- j 2 π r}{N} ( \frac{{k}^{2}}{2} + qk ) \} {b}_{i} ( k mod m ) & [ 6 ]\end{matrix}$$

Here, k=0, 1, . . . and N−1, “N” and “r” are coprime, and r is an integer smaller than N. Also, “p” represents an arbitrary integer (generally p=0). Also, bᵢ(k mod m) is an arbitrary complex number and i=0, 1, . . . and m−1. To minimize cross-correlation between GCL sequences, an arbitrary complex number of amplitude is used for bᵢ(k mod m). In this way, the GCL sequences represented by equations 5 and 6 are found by multiplying bᵢ(k mod m) by ZC sequences represented by equations 1 and 2.

Further, the present invention may be applicable to binary sequences and other CAZAC sequences where a cyclic shift sequence or ZCZ sequence is used for a coding sequence. For example, there are Frank sequences, random CAZAC sequences, OLZC sequences, RAZAC sequences, other CAZAC sequences (including sequences generated by computers) and PN sequences including M sequences and gold sequences.

Furthermore, a modified ZC sequence obtained by puncturing, performing cyclic extension or performing truncation on a ZC sequence may be applied.

Further, although cases have been described with the above embodiment as examples where the present invention is configured by hardware, the present invention can also be realized by software.

Each function block employed in the description of each of the aforementioned embodiments may typically be implemented as an LSI constituted by an integrated circuit. These may be individual chips or partially or totally contained on a single chip. “LSI” is adopted here but this may also be referred to as “IC,” “system LSI,” “super LSI,” or “ultra LSI” depending on differing extents of integration.

Further, the method of circuit integration is not limited to LSIs, and implementation using dedicated circuitry or general purpose processors is also possible. After LSI manufacture, utilization of a programmable FPGA (Field Programmable Gate Array) or a reconfigurable processor where connections and settings of circuit cells within an LSI can be reconfigured is also possible.

Further, if integrated circuit technology comes out to replace LSI's as a result of the advancement of semiconductor technology or a derivative other technology, it is naturally also possible to carry out function block integration using this technology. Application of biotechnology is also possible.

The disclosure of Japanese Patent Application No. 2007-337242, filed on Dec. 27, 2007, including the specification, drawings and abstract, is incorporated herein by reference in its entirety.

### INDUSTRIAL APPLICABILITY

The present invention is applicable to, for example, mobile communication systems.

1. A sequence hopping method of performing sequence hopping using a first Zadoff-Chu sequence and a second Zadoff-Chu sequence obtained by adding an amount of hopping to the first Zadoff-Chu sequence, wherein different amounts of hopping are given to a plurality of second Zadoff-Chu sequences having varying sequence lengths.

2. The sequence hopping method according to claim 1, wherein the different amounts of hopping have values obtained by multiplying the varying sequence lengths by amounts of u/N bopping (u: sequence index and N: sequence length).

3. A radio communication terminal apparatus comprising:
a determination section that determines a sequence index of a first Zadoff-Chu sequence and a sequence index of a second Zadoff-Chu sequence obtained by adding an amount of hopping to the first Zadoff-Chu sequence, based on associations between sequence lengths of Zadoff-Chu sequences and sequence indexes of the Zadoff-Chu sequences; and
a generation section that generates each of Zadoff-Chu sequences based on the determined sequence index,
wherein different amounts of hopping are given to a plurality of second Zadoff-Chu sequences having varying sequence lengths.

4. A radio communication base station apparatus comprising:
a determination section that determines a sequence index of first Zadoff-Chu sequence and a sequence index of a second Zadoff-Chu sequence obtained by adding an amount of hopping to the first Zadoff-Chu sequence, based on associations between sequence lengths of Zadoff-Chu sequences and sequence indexes of the Zadoff-Chu sequences; and
a generation section that generates each of Zadoff-Chu sequences based on the determined sequence index,
wherein different amounts of hopping are given to a plurality of second Zadoff-Chu sequences having varying sequence lengths.
